(19) United States
(12) Patent Application Publication
(10) Pub. No.: US 2009/0119327 A1
(43) Pub. Date: May 7, 2009

(54) R-SMART PERSON-CENTRIC NETWORKING

(75) Inventor: Thomas W. Lynch, Galveston, TX (US)

Correspondence Address: AMIN, TUROCY & CALVIN, LLP, 127 Public Square, 57th Floor, Key Tower, CLEVELAND, OH, 44114, US

(73) Assignee: LIANG HOLDINGS LLC, Wilmington, DE (US)

(21) Appl. No.: 11/936,682

(22) Filed: Nov. 7, 2007

(51) Int. Cl. G06F 17/30

(52) U.S. Cl. 707/102; 707/100; 707/E17.005

(57) ABSTRACT

Implementations related to r-smart person-centric networks are disclosed.

### BACKGROUND

Communication is an increasingly important component of most people's lives and the average person may make contact with hundreds of other people. There is an increasing trend in the number of contacts, and this has created new challenges for managing contacts.

Some social scientists maintain that most communication is emotional and that analytical content is secondary, if present at all. Whether justified or not, caring and emotions are frequently termed “right brain” activities, and hence being good at these activities is sometimes referred to as “r-smartness” which is short for “right brain smartness”.

People often use r-smartness in determining how they communicate with other people. In some cultures this may be very pronounced, and may even affect the vocabulary and grammar of a conversation. For example, in pre-modern Europe, third person and indirect terms were used when conversing with royalty. As another example, in Japan different forms are used depending on whether one is speaking to children, family, co-workers, elders and bosses. Take for instance the Japanese word for thank you. It may take the form of “domo”, “domo arigato”, and “domo arigato gozaimasu” depending on the perceived acting role and status difference in the conversation. Thus, in this context, acting roles may include such things as parent-child, student-teacher, employee-boss, among others. Furthermore, status differences may be based on age, attainment in a skill, spiritual attainment, money, among others. Indeed, this also exists in a less formal form in American English with “thanks”, “thank you”, and “thank you very much” and other variations said in different tones and intonations. However, r-smartness comes into play in a variety of situations, not just when saying thank you.

As telecommunication means have diversified from simple land-line phones to include, among others, personal digital assistants (PDAs), cell phones, email devices such as desktop computers and laptops, and the like, the use of simple phone books and operator assistance may no longer be optimum means for keeping track of contacts. As a result, personally owned contacts lists are playing a larger role in people's lives. Enhancing such personally owned contacts lists may result in smoother communications and enhanced productivity.

Moreover, other forces, such as high-powered marketing and identity theft, have caused people to become more reticent about giving out or publishing contact information. This trend has placed pressure on individuals to organize their own contact lists rather than to rely upon a central source such as a phone book or directory service, so that, once again, the personal contacts list, and r-smartness is becoming more important.

### BRIEF DESCRIPTION OF THE DRAWINGS

Subject matter is particularly pointed out and distinctly claimed in the concluding portion of the specification. Claimed subject matter, however, both as to organization and method of operation, together with objects and features thereof, may best be understood by reference of the following detailed description if read with the accompanying drawings in which:

FIG. 1 illustrates an example of an implementation of an r-smart person-centric hub and spoke network;

FIG. 2 illustrates an example of an implementation of an r-smart person-centric network;

FIG. 3 illustrates a textual representation of the example implementation of FIG. 2;

FIG. 4 illustrates an example of an implementation of a hierarchical r-smart person-centric network;

FIG. 5 illustrates an example contact form that may be utilized with the example implementations of FIGS. 2-4;

FIG. 6 illustrates an example system; and

FIG. 7 illustrates an example method.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the following detailed description are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing may involve physical manipulations of physical quantities. Typically, although not necessarily, these quantities may take the form of electrical, magnetic and/or electromagnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices.

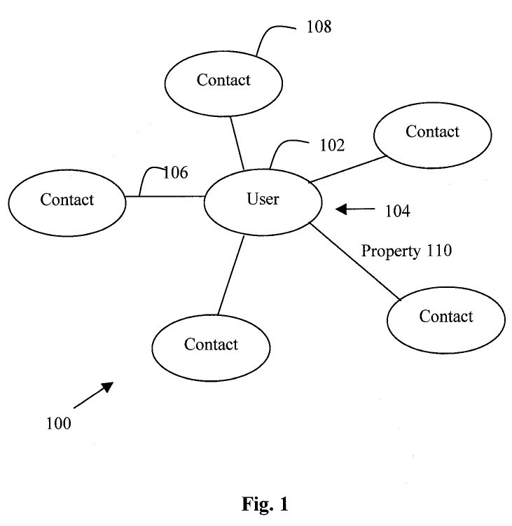

FIG. 1 illustrates one implementation of a person-centric network 100 in accordance with claimed subject matter. A person-centric network in accordance with claimed subject matter may comprise and/or be represented as a “hub and spoke” network with a person at the hub of the network, and people and/or entities they know on the other end of the spokes. Thus, in the example implementation of network 100, a contact database user 102 is located in the center of network 100 as a hub 104 of network 100. From hub 104 a plurality of spokes 106 connect user 102 to a plurality of contacts 108. User 102 and/or contacts 108 may comprise persons and/or entities such as business entities, for example.

In accordance with some implementations of claimed subject matter any one of spokes 106 may be associated with one or more “emotience” or “emotient” attributes, emotient characteristics and/or emotient properties 110. In some implementations, an emotient property 110 associated with a spoke 106 may comprise a property value list including, in a non-limiting manner, such characteristics as familiarity, affection, respect and/or respect level, esteem and/or esteem level, status and/or status difference, acting role, among others. In other words, such properties may reflect how a user feels about a personal contact.

Further, an emotient property may or may not have a value; the value in turn may be a property, or even another property value list. Thus, in some implementations of claimed subject matter, an emotient property comprising a familiarity property may have an integer value that describes how well user 102 knows one of contacts 108. For example, an integer value of “0” may represent user 102 having no familiarity with a particular contact 108, while an integer value of “10” may represent user 102 having intimate knowledge of a particular contact 108. In other implementations of claimed subject matter, rather than numerical values, values associated with an emotient property such as a familiarity property may comprise another property value list such as “stranger”, “acquaintance”, “close”, and “intimate” among other possibilities.

In some implementations of claimed subject matter an emotient property 110 may be associated with derived properties where derived properties may comprise properties derived from a base or fundamental property value list comprising a property 110. Accordingly, properties that appear in a base property value list may be considered to be fundamental properties while derived properties may be created from fundamental properties by a rule, set of rules, algorithm, program or the like. In various implementations, derived properties may be created dynamically as needed, may be stored back into a base property value list, and/or may be placed in one or more auxiliary property value lists.

As one example among many, a derived property of affection could be determined from fundamental emotient properties such as familiarity, acting role, etc. In this context, an example rule for creating a derived property of affection may be to assume affection for the acting role of ‘wife’. In general, rules and algorithms for generating derived properties may combine a number of factors, some of which may be externally influenced. An example of an externally influencing factor may comprise a “number_of_contacts” factor. Such a factor may comprise an emotient property taking an integer value that an algorithm increments each time contact is made with a particular person. Thus, for example, an r-smart contacts database in accordance with some implementations of claimed subject matter may then derive a value for an affection, or similarly-named, property based on a respect level and a number of contacts provided by the integer value.

As another implementation of derived properties in accordance with claimed subject matter, one or more emotient properties may be determined based on common properties, and/or common property values among a plurality of contacts. In this context the term “ring” may be used to describe the grouping of contacts and the phrase “ring properties” may be used to describe emotient properties associated with a group of contacts. Similar meanings of the term “ring” may be found, for example, in the area of abstract algebra, and in colloquial terms such as “crime ring”. Claimed subject matter is not limited in this regard however, and, thus, a grouping of contacts in accordance with claimed subject matter may be described as a “ring”, a “group”, a “domain”, to name just a few examples. Thus, within this disclosure, use of the term “ring” should not be understood as describing a literal geometric shape, even though such shapes may be employed in network diagrams, etc., that may be used to illustrate example implementations of claimed subject matter.

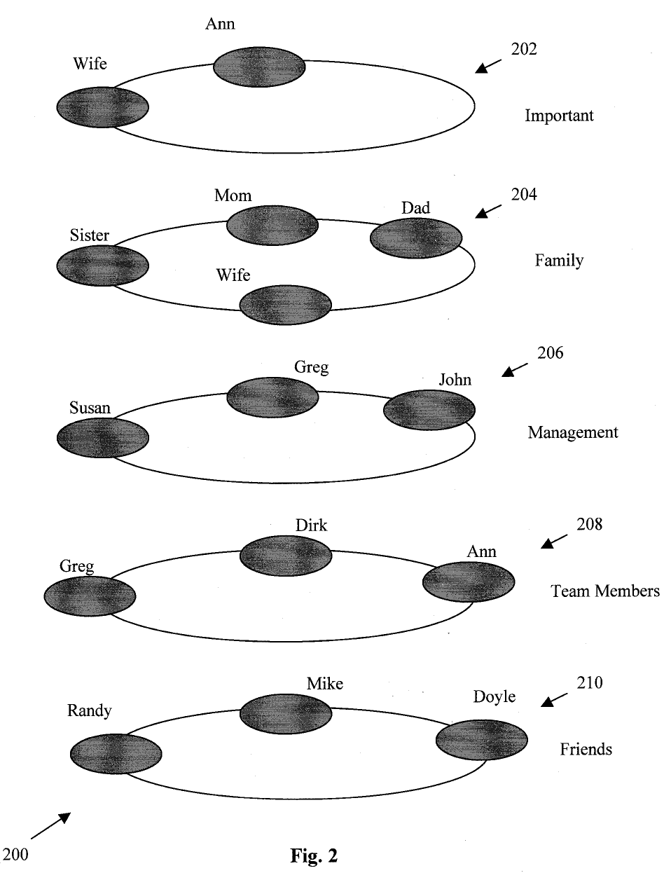

FIG. 2 illustrates an example implementation of a person-centric network 200 in accordance with claimed subject matter. In FIG. 2, an example “acting role” derived property has generated a plurality of rings 202, 204, 206, 208 and 210, carrying the values of “important”, “family”, “management”, “team member”, and “friend”, respectively. In some implementations, such as network 200, the common property and/or property value associated with the one or more subsets of contacts may be used to label or name the rings derived from those one or more subsets of contacts.

In comparison to FIG. 1, where emotient properties 110 were illustrated associated with spokes 106 connecting user 104 to various contacts 108, network 200 is illustrated without spokes because contacts within each ring 202-210 share a common emotient property and/or property value with respect to a user of network 200. For example, all contacts of ring 202 share a common property value, in this example, the value of “important”, with respect to a user of network 200. Thus, spokes are not shown explicitly in network 200 because they may be implied from the definition of the term ring as provided herein. Similarly, no hubs (associated with a user of network 200) have been illustrated in FIG. 2 because they may be implied as well.

FIG. 3 illustrates an example, in accordance with claimed subject matter, of a textual rendering 300 of network 200. While textual rendering 300 may not illustrate contact groupings having particular geometric shapes such as rings, it conveys the same information as conveyed in FIG. 2.

### User Interface Network Editor and Viewer

In some implementations of claimed subject matter, r-smart information associated with a person-centric network may be created, edited, and/or viewed by separate programs, or a combined program in order to create editor/viewer functions. Such a program or collection of programs may be called an “emotience manager” although claimed subject matter is not limited in this regard. Such a program or programs may render r-smart information in graphical form as shown in FIGS. 1 and 2, in textual form as shown in FIG. 3, or in a number of other forms, where that graphical form may comprise at least a portion of a graphical user interface (GUI) capable of being displayed on a display device. The particular form used may be a user preference, or even a function, for example, of a display device employed by a user. For example, for a user employing a cell phone to view a person-centric network, a textual form as shown in FIG. 3 may comprise an optimal graphical format. Further, a user interface network editor and/or viewer may, in accordance with claimed subject matter, be accessed (e.g., for reading and/or editing) by software applications that are compatible with person-centric networks.

In some implementations, a user may select (e.g., click on) a display form to cause one or more actions to occur. For example, a user clicking on a category label may cause an underlying list to collapse or expand. Further, a user clicking on elements of a list may cause details for a contact to be rendered. Rendering of such details may be provided by an editor function where contact information may be modified and or supplemented, and preferences such as a primary label, for example, may be set.

It should now be apparent to those skilled in the art, that rendering or bringing only contextually appropriate information to the forefront may also be applied when different user interfaces are employed, including a GUI. Another possible filtering interface may comprise an interface that allows a user to explicitly select desired rings to be shown. Such an interface may present a dialog box, and allow a user to enter the names of one or more rings into the dialog box. A possible further extension of this implementation may interpret user input as a regular expression, and then present all matching categories.

In accordance with some implementations of claimed subject matter, a ring method of organizing contacts may provide a user with greater flexibility to segment contact lists into contexts that apply at any particular moment, while leaving out or de-emphasizing those that do not. Thus, for example, a user may filter communications with contacts based upon how the user feels about various contacts at particular times and/or in particular contexts. As an example of this filtering, a user who is at the office may feel that communications with co-workers and/or supervisors are more important and thus may turn off or de-emphasize family and/or friend's rings so that more immediately useful work-related contacts are emphasized in the foreground of an interface's graphical rendering. Whereas, in contrast, a user in the context of a family event, such as wedding or family reunion, may feel that family contacts are more important and therefore make a family ring the immediate and most easily accessible ring.

### Hierarchical Rings

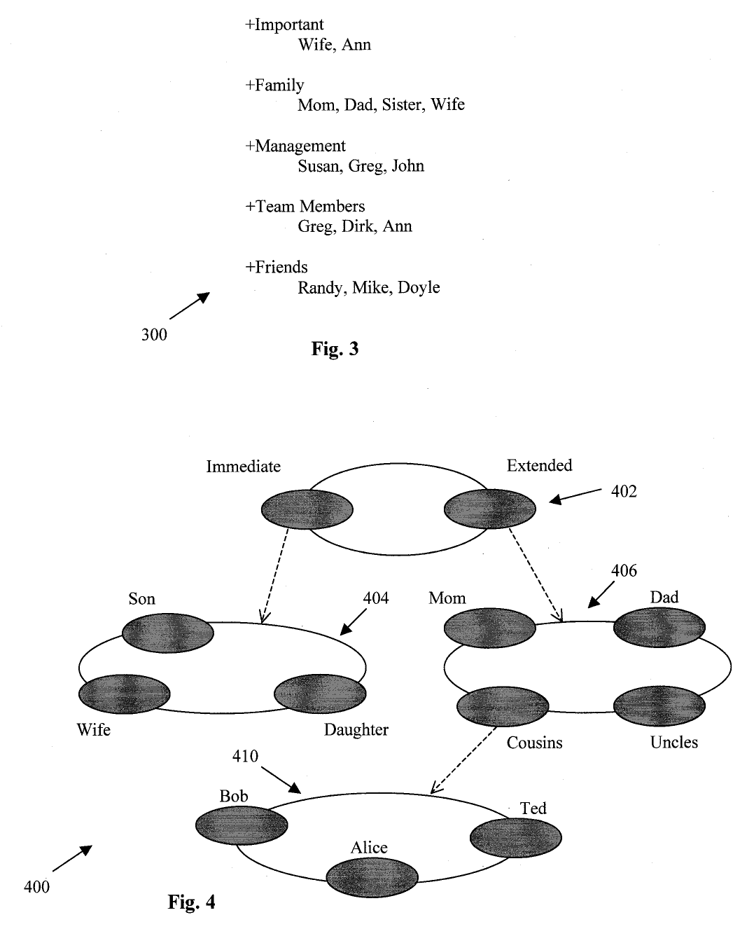

In accordance with some implementations, r-smart person-centric networks may be hierarchical in format. For example, a “family” ring or group may be further broken down into sub-rings or sub-groups such as “immediate family” (such as wife, son, daughter, etc.), and “extended family” (such as mom, dad, uncle, cousin, etc.). Such hierarchical groupings may extend for multiple levels of sub-rings; for example, “cousins” in an extended family ring might open up or be selectable to reveal a sub-ring providing a list of all cousins. For example, FIG. 4 illustrates an example ring network 400 where a “family” ring 402 having “immediate family” and “extended” family contacts supports sub-rings 404 and 406 comprising, respectively, contacts within the immediate family and contacts within the extended family. The contact 408 labeled “cousins” in the extended family sub-ring 406 may then spawn a further sub-ring 410 comprising all cousin contacts. As noted above, contacts within rings or sub-rings of network 400, may, depending on the user interface employed to display network 400, permit a user to select a contact, such as, for example, the “cousins” contact 408 of extended family sub-ring 406, to display any associated sub-rings such as sub-ring 110.

### Nature of Contact Information

In general, contact information may be quite extensive and/or arbitrary. In some implementations of claimed subject matter, the nature of contact information may reflect an application and/or a ring. For example, friends and family contacts may have names and addresses with phone numbers and email addresses. In contrast, employment-related contacts may include office addresses and phone extensions. In some implementations of claimed subject matter, a context of a contact may be entered along with other contact information. For example, in accordance with some implementations of claimed subject matter a contact manager enhanced to support r-smart person-centric networks may provide an enhanced format for a user to enter contact information.

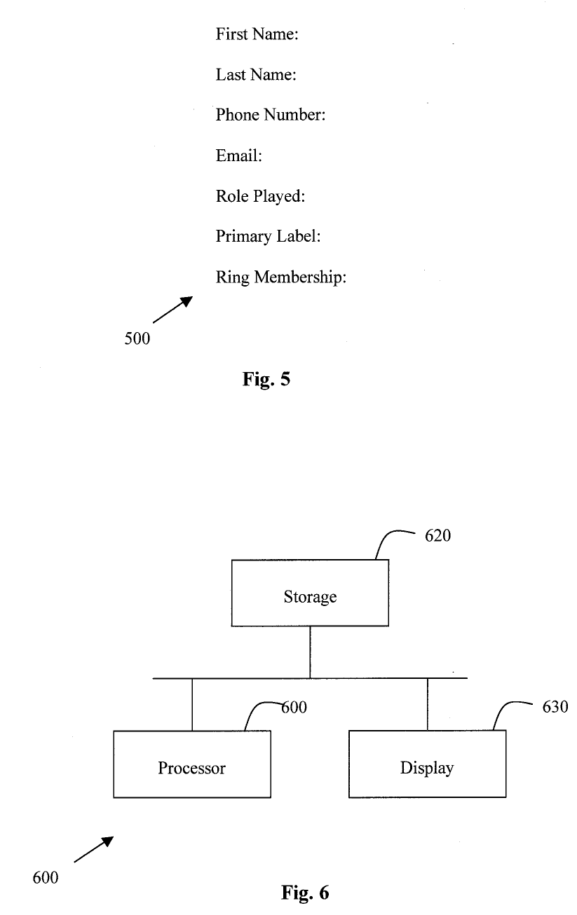

FIG. 5 shows one example embodiment of an enhanced contact form 500 in accordance with some implementations of claimed subject matter. Of course, form 500 is just one of many possible contact forms suitable for person-centric networks. As shown in FIG. 5, the example of form 500 includes the following fields for entering contact information: first name, last name, phone number, email, role played, primary label, and ring membership. Thus, using enhanced form 500 a user may directly enter a role played by a contact, a primary label associated with a contact and a list of ring memberships for a contact. For example, for a business contact that is also a friend, a user of form 500 may enter a primary label of “work” for that contact while also listing membership for that contact in both a “work” ring and a “friends” ring.

In other implementations in accordance with claimed subject matter, an application may support a ring manager separate from a contacts list manager. In such implementations, a user may add contacts to one or more rings rather than adding rings to the contacts. Many other variations will be apparent to those skilled in the art.

In yet other implementations in accordance with claimed subject matter, a primary label may be implied or derived from other information potentially in combination with user preferences. Further, some or all of the information on a form may be optional. In addition, there may be a default ring for those who are not placed on any ring.

### Internal Representation

In some implementations in accordance with claimed subject matter, r-smart person-centric networks such as rings may be internally defined using list structures. Accordingly, the head of a list may comprise a ring name, and subsequent members of the list may comprise references to members of a ring. Sub-lists may represent hierarchical information within such list structures.

For example, a person-centric list structure in accordance with claimed subject matter might take the following form: (ring-top (Important Wife Ann) (Family Mom Dad Sister Wife (cousins Rick Rob Cindy Kevin)) (Management Susan Greg John) (Team Members Greg Dirk Ann) (Friends Randy Mike Doyle)).

Such person-centric list structures in accordance with claimed subject matter may be in various formats such as American Standard Code for Information Interchange (ASCII) format, binary format, etc, the particularly format not being limiting. In some implementations, labels such as the primary label “important” may comprise references such as database keys or address pointers, among many other possibilities. Further, instead of a list structure, some implementations in accordance with claimed subject matter may employ data structures or arrays to define r-smart person-centric networks. Many other forms of internal representations will be apparent to those skilled in the arts of computer programming.

### Special Rings

Some implementations in accordance with claimed subject matter may define special rings. Such special rings may include, for example, “everybody” and “nobody” rings where an everybody ring may comprise a flat contact list that includes all contacts, and a nobody ring may contain all contacts that do not belong to any other ring. Various implementations may give such special rings names other than “everybody” and “nobody”.

### Example System

FIG. 6 is a block diagram of an example communications system 600. System 600 may be used to perform some or all of the various functions discussed above in connection with FIGS. 1-5. System 600 may comprise any device or collection of devices capable of facilitating communication of information. For example, system 600 may comprise a terminal device such as a desktop computer, a laptop computer, a handheld computer, a smart and/or cellular telephone, a PDA, etc.

System 600 includes a central processing unit (CPU) 610 such as a processor capable of providing and/or facilitating communications functions, memory 620 coupled to CPU 610, and a display device 630 coupled to CPU 610 and/or memory 620. It will be recognized by those skilled in the art that a graphics processing unit (GPU), not shown in FIG. 6, may be coupled to CPU 610 and/or may be internal to CPU 610, and may be coupled to display device 630 in order to provide display device 630 with displayable information. Such displayable information may be presented on display device 630 in the form of a GUI where that GUI may be capable of providing visual representations of r-smart person-centric networks in accordance with some implementations of claimed subject matter.

In accordance with some implementations of claimed subject matter, CPU 610 may include logic adapted to facilitate, build, generate and/or operate on internal representations such as list structures, data structures and/or arrays used to define r-smart person-centric networks. Further, in accordance with some implementations of claimed subject matter, memory 620 may act in conjunction with CPU 610 to store or hold at least portions of such internal representations.

Those skilled in the art will recognize that memory 620 and/or CPU 610 may be further coupled to a memory controller, not shown in FIG. 6, that may facilitate the communication of information, such as information specifying a GUI, between CPU 610 and/or memory 620. Further, memory 620, which may comprise memory internal to CPU 610, and/or which may comprise one or more discrete memory devices external to CPU 610, may comprise any memory technology (e.g., random access memory (RAM), flash memory, etc.). In accordance with some implementations of claimed subject matter, memory 620 may, at least temporarily, store or hold information capable of providing visual representations of r-smart person-centric networks. Such information may comprise, for example, information specifying at least portions of a GUI capable of providing visual representations of r-smart person-centric networks and capable of being displayed on display device 630.

Display device 630 may comprise any type of display device such as a Liquid Crystal Display (LCD) display, a polymer-based display, an electroluminescent display, a Plasma Display Panel (PDP), or a Cathode Ray Tube (CRT) display, to name a few of the more prominent examples. Although example system 600 is shown with a particular configuration of components, other implementations are possible using any of a wide range of configurations. Further, those skilled in the art will recognize that system 600 may include many additional components such as communications busses etc., not particularly germane to claimed subject matter, that have not been illustrated in FIG. 6 in the interests of not obscuring claimed subject matter.

### Example Method

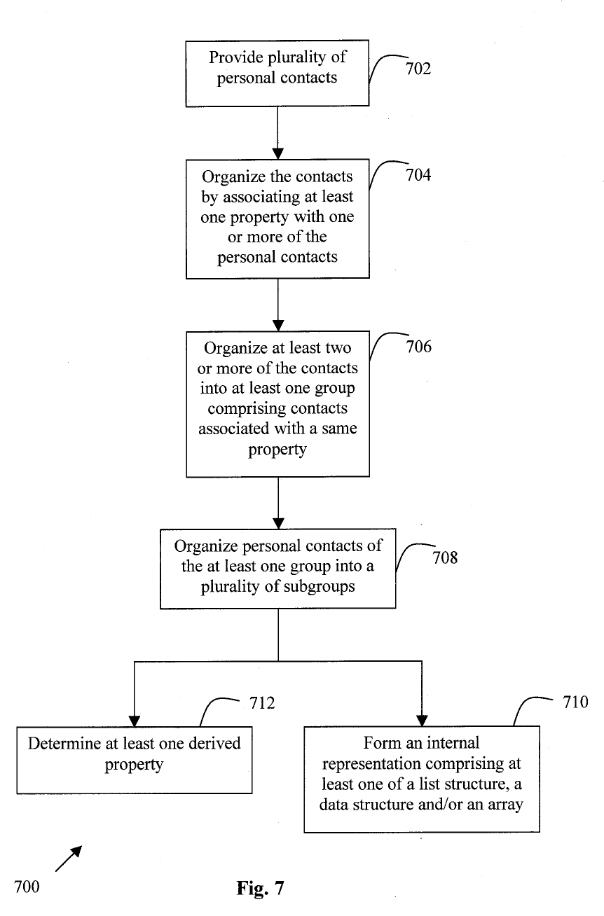

FIG. 7 is a flow diagram of an example method 700 in accordance with some implementations of claimed subject matter. Method 700 may implement and/or perform some or all of the various functions and/or schemes discussed above in connection with FIGS. 1-5 and details regarding the various acts of method 700 have been provided above in reference to those figures and will not be repeated below in the discussion of FIG. 7. Any ordering of the acts shown in FIG. 7 does not limit claimed subject matter and does not imply that the acts must be undertaken in the order shown and/or that any particular act in FIG. 7 is necessarily dependent upon another act.

In act 702, a plurality of personal contacts may be provided, while in act 704 those personal contacts may be organized by associating them with at least one emotient property. Further, in act 706, at least some of those contacts received in act 702 may be organized into at least one group (e.g., a ring) comprising contacts having a common property. The at least one group formed in act 706 may, in act 708, be further organized into a plurality of sub-groups. In addition, in act 710, an internal representation of the groups and/or sub-groups may be formed comprising at least one of a list structure, a data structure and/or an array. Also, in act 712, at least one derived property may be determined.

While particular implementations have just been described, claimed subject matter is not limited in scope to one or more particular implementations. For example, some implementations may be in hardware, such as employed to operate on a device or combination of devices, for example, whereas other implementations may be in software. Further, some implementations may be employed in firmware, or as any combination of hardware, software, and/or firmware, for example. Likewise, although claimed subject matter is not limited in scope in this respect, some implementations may comprise one or more articles, such as a storage medium or storage media. This storage media, such as, one or more CD-ROMs, computer disks, flash memory, or the like, for example, may have instructions stored thereon, that, when executed by a system, such as a computer system, computing platform, or other system, for example, may result in execution of an implementation of a method in accordance with claimed subject matter, such as one of the implementations previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations. Also, as used herein, the article “a” includes one or more items. Moreover, when terms or phrases such as “coupled” or “responsive” or “in response to” or “in communication with” are used herein or in the claims that follow, these terms should be interpreted broadly. For example, the phrase “coupled to” may refer to being communicatively, electrically and/or operatively coupled as appropriate for the context in which the phrase is used.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now, or in the future, occur to those skilled in the art. It is, therefore, to be understood that the appended claims are intended to cover all such modifications and/or changes as fall within the true spirit of claimed subject matter.

What is claimed:

1. A method comprising:
providing a plurality of personal contacts; and
organizing the plurality of personal contacts by associating an emotient property with one or more of the personal contacts;
wherein the emotient property comprises at least one of familiarity, affection, respect, esteem, status, and/or acting role.

2. The method of claim 1, wherein organizing the plurality of personal contacts further comprises:
organizing at least two or more of the personal contacts into a group comprising contacts associated with a same emotient property.

3. The method of claim 2, wherein organizing the plurality of personal contacts further comprises:
organizing personal contacts of the group into a plurality of sub-groups.

4. The method of claim 1, wherein the emotient property is associated with a value.

5. The method of claim 4, wherein the value comprises an integer value.

6. The method of claim 1, wherein organizing the plurality of personal contacts further comprises:
determining a derived property from the emotient property.

7. The method of claim 1, wherein organizing the plurality of personal contacts by associating an emotient property with one or more of the personal contacts results in an r-smart person-centric network.

8. The method of claim 7, wherein the r-smart person-centric network comprises one of a ring network and a hub and spoke network.

9. The method of claim 7, wherein the r-smart person-centric network is capable of being created, edited, and/or viewed by one or more algorithms.

10. The method of claim 1, further comprising:
forming an internal representation including the emotient property;
wherein the internal representation comprises at least one of a list structure, data structure, and an array.

11. The method of claim 1, wherein the emotient property comprises an emotience characteristic and/or attribute.

12. The method of claim 1, wherein an acting role comprises at least one of family member, sibling, spouse, co-worker, supervisor, and friend.

13. A representation of a network of personal contacts, the representation adaptable to be rendered by a graphical user interface, the representation comprising:
an indication of a plurality of personal contacts; and
an indication of an emotient property associated with at least one of the plurality of personal contacts;
wherein the emotient property comprises at least one of familiarity, affection, respect, esteem, status, and acting role.

14. The representation of claim 13, further comprising:
an indication of two or more personal contacts formed into a group associated with the emotient property.

15. The representation of claim 14, further comprising:
an indication of at least one of the two or more personal contacts formed into a sub-group associated with the group.

16. The representation of claim 13, wherein the emotient property is associated with a value.

17. The representation of claim 16, wherein the value comprises an integer value.

18. The representation of claim 13, further comprising:
an indication of a property derived from the property.

19. The representation of claim 13, wherein the representation comprises an r-smart person-centric network.

20. The representation of claim 19, wherein the r-smart person-centric network comprises one of a ring network and a hub and spoke network.

21. The representation of claim 13, wherein the emotient property comprises an emotience characteristic and/or attribute.

22. The representation of claim 13, wherein an acting role comprises at least one of family member, sibling, spouse, co-worker, supervisor, and friend.

23. A system, comprising:
a processor;
memory coupled to the processor; and
a display coupled to the processor;
wherein the processor is adapted to provide a representation of a network of personal contacts to the display;
wherein the representation comprises:
an indication of a plurality of personal contacts; and
an indication of an emotient property associated with at least one of the plurality of personal contacts;
wherein the emotient property comprises at least one of familiarity, affection, respect, esteem, status, and acting role.

24. The system of claim 23, wherein the memory is adapted to store at least a portion of the representation.

25. The system of claim 23, wherein the display is adapted to provide a graphical user interface including at least a portion of the representation.

26. The system of claim 23, wherein an acting role comprises at least one of family member, sibling, spouse, co-worker, supervisor, and friend.

27. An article comprising: a storage medium having stored therein instructions that, if executed, result in:
providing a plurality of personal contacts; and
organizing the plurality of personal contacts by associating an emotient property with one or more of the personal contacts;
wherein the emotient property comprises at least one of familiarity, affection, respect, esteem, status, and/or acting role.

28. The article of claim 27, wherein said instructions, if executed, further result in:
organizing at least two or more of the personal contacts into a group comprising contacts associated with a same emotient property.

29. The article of claim 28, wherein said instructions, if executed, further result in:
organizing personal contacts of the group into a plurality of sub-groups.

30. The article of claim 27, wherein the emotient property is associated with a value.

31. The article of claim 30, wherein the value comprises an integer value.

32. The article of claim 27, wherein said instructions, if executed, further result in:
determining a derived property from the emotient property.

33. The article of claim 27, wherein said instructions to organize the plurality of personal contacts by associating an emotient property with one or more of the personal contacts, if executed, further result in:
forming an r-smart person-centric network.

34. The article of claim 33, wherein the r-smart person-centric network comprises one of a ring network and a hub and spoke network.

35. The article of claim 33, wherein the r-smart person-centric network is capable of being created, edited, and/or viewed by one or more algorithms.

36. The article of claim 27, wherein said instructions, if executed, further result in:
forming an internal representation including the emotient property;
wherein the internal representation comprises at least one of a list structure, data structure, and an array.

37. The article of claim 27, wherein the emotient property comprises an emotience characteristic and/or attribute.

38. The article of claim 27, wherein an acting role comprises at least one of family member, sibling, spouse, co-worker, supervisor, and friend.

39. An apparatus, comprising:
logic adapted to provide a representation of a plurality of personal contacts;
wherein the representation comprises:
an indication of the plurality of personal contacts; and
an indication of an emotient property associated with at least one of the plurality of personal contacts;
wherein the emotient property comprises at least one of familiarity, affection, respect, esteem, status, and acting role.

40. The apparatus of claim 39, further comprising:
memory adapted to store at least a portion of the representation.

41. The apparatus of claim 39, further comprising:
a display adapted to provide a graphical user interface including at least a portion of the representation.

42. The apparatus of claim 39, wherein an acting role comprises at least one of family member, sibling, spouse, co-worker, supervisor, and friend.

43. The apparatus of claim 39, wherein the logic is housed in one of a computer, a telephone, and a personal digital assistant.
